(19) United States
(12) Patent Application Publication
(10) Pub. No.: US 2012/0259774 A1
(43) Pub. Date: Oct. 11, 2012

(54) PAYMENT METHODS USING ELECTRONIC DEVICES

(76) Inventor: Antonio Brunel Marti, Xalapa, Veracru, (MX)

(21) Appl. No.: 13/394,143

(22) PCT Filed: Sep. 3, 2010
(86) PCT No.: PCT/US10/47876

§ 371 Date: May 29, 2012

(30) Foreign Application Priority Data
Sep. 3, 2009 (MX) MX/A/2009/009454

(51) Int. Cl. G06Q 20/32; G06Q 20/16; G06Q 20/34; G06Q 40/02

(52) U.S. Cl. 705/41; 705/42

(57) ABSTRACT

Various payment methods utilizing wireless or wired devices are disclosed, such devices that use radio electric spectrum frequencies. The methods include all types of payment operation transactions utilizing conventional financial instruments. These methods include authentication processes, information encryption, and encryption certificaton to guarantee the security of the transactions.

### CROSS REFERENCE TO RELATED APPLICATIONS

The present application claims priority to MX/a/2009/009454 filed on Sep. 3, 2009 and entitled “Payment Methods Using Electronic Devices,” and is hereby incorporated by reference.

### BACKGROUND

Currently, there has been a tremendous and unprecedented growth in mobile telephone communication systems. In addition, the appearance of mobile phones and other portable communication devices is ubiquitous in all the world, to the degree that it is estimated that at least 80% of the world's population has access to mobile telephone coverage or similar technologies.

The installed base of mobile phones and other portable communication devices has increasingly incorporated more and better applications that have transformed these phones and devices into multi-purpose systems, with almost unlimited capacities and functionalities, and these systems are growing exponentially on a daily bases.

On the other hand, traditional payment methods always have had and will continue to have a variety of limitations, such as the time involved in using them, the possibility of fraudulent transactions, communication problems, security risks and many more problems that are evident to any professional in the industry.

There is still a tremendous need for ways to provide payment methods that are easy and safe, via both electronic and wireless devices that use the radio electric spectrum, such as mobile phones and other portable communication devices, as well as via wired transmissions, in both cases that would effectively serve the needs of both the high-income and low-income populations, by providing pre and post-payment plans.

Because of this, there is also a need to provide payment methods via electronic devices that utilize all types of wired transmissions, in a manner that is easy and safe, and particularly within the reach of both the low-income and high-income populations, in pre-paid and post-paid plans.

### SUMMARY OF THE INVENTION

This invention meets these and other needs, by providing various effective methods to facilitate payments in ways that are diverse, wide-ranging, and versatile, using current technologies as well as those being used conventionally, on a wide range of platforms that offer the needed security. The methods of the present invention utilize traditional and conventional financial services that are accessible to all economic levels of the population. This invention provides various payment methods utilizing wireless electronic devices, such as wireless electronic devices that use radio electric spectrum frequencies. These methods include the following steps:
determine mobile phone or portable communication device connections, and establish connections with them;
review customer/user information of these mobile phones or portable communication devices;
verify the existence of customer/user balances and existing authorizations to perform operations;
verify the customer/user and record the amount of the payment operation requested by the customer/user;
transfer the amount of the payment operation requested by the customer/user; and
confirm that the payment operation transaction was carried out.
In particular, the methods of this invention include facilitating operation transactions, only as an example but not limited to those such as:
a) pre-payment of electronic airtime from conventional telephony companies (wired telephony) or those that use radio electric spectrum frequencies (wireless telephony);
b) cards, with printed digital codes, that are inserted into the keypad of either a conventional telephone or one that uses the radio electric spectrum, in order to allow the buyer to make long distance national and international calls, using a pre-paid or post-paid plan;
c) use of the Internet and/or information systems for periods of a year, month, day or fractions thereof, or any other determined period of time;
d) airplane or land transportation tickets;
e) tickets to cultural, social or recreational events;
f) tickets to lotteries, raffles, drawings and sports wagering events;
g) national and international money transfers;
h) electronic transmission services for movies, radio and television programs, either live, delayed or per view;
i) movies, radio and television programs either live, delayed or per view;
j) prepared foods;
k) food and groceries in general and other merchandise;
l) food preparation orders either to be eaten in a restaurant or for take-out;
m) purchase orders for grocery, supermarket or market products;
n) purchase or delivery orders for industrial and office supplies;
o) purchase or delivery orders of construction materials or manufacturing raw materials;
p) purchase or delivery orders for medicines; and
q) purchase of tickets to cultural, social or recreational events.

In order to carry out the methods involved in this invention, consideration is being given to the use of a variety of devices that via keypads, buttons, or specific or alphanumeric function keys, use radio electric spectrums to transmit voice, data or information that carry them via these radio electric spectrum frequencies and via digital devices to the various telecommunication company telephone exchanges and from there, using communication links via any of the methods, only as an example but not limited to the following:
i) Internet;
ii) Frame-Relay;
iii) X25;
iv) MPLS;
v) PPTP;
vi) PPOE;
vii) GPRS;
viii) TDMA,
   as well as the TCP/IP communication protocol, version 4, version 6, or any other later or future version, to communicate with computer equipment or application servers that, using the methods described in this invention, process the information so that the result is the transaction of payments for services and goods described herein, using any of the following methods:
bank card or commercial credit card;
bank card or commercial debit card;
pre-paid bank card or commercial credit card;
transfer of funds between bank accounts, merchants, savings institutions, investment companies and pawn shops;
bank deposits made in cash or check in any currency, including payment requests.

Additionally, this invention also provides payment methods via electronic devices that use wired transmissions, such as copper or precious, semi-precious metal cables, mono-mode or multiple mode fiber optics, laser beams or radio electric spectrum emissions in infrared bands. The methods of the invention, secondly, consist of these steps:
determine mobile phone or portable communication device connections, and establish connections with them;
review customer/user information of these mobile phones or portable communication devices;
verify the existence of customer/user balances and existing authorizations to perform operations;
verify the customer/user and record the amount of the payment operation requested by the customer/user;
transfer the amount of the payment operation requested by the customer/user; and
confirm the payment operation transaction was carried out.

The methods of this invention include transaction of operations, only as an example but not limited to the following:
a) pre-payment of electronic airtime from conventional telephony companies (wired telephony) or those that use radio electric spectrum frequencies (wireless telephony);
b) cards, with printed digital codes, that are inserted into the keypad of either a conventional telephone or one that uses the radio electric spectrum, in order to allow the buyer to make long distance national and international calls, using a pre-paid or post-paid plan;
c) use of the Internet and/or information systems for periods of a year, month, day or fractions thereof, or any other determined period of time;
d) airplane or land transportation tickets;
e) tickets to cultural, social or recreational events;
f) tickets to lotteries, raffles, drawings and sports wagering events;
g) national and international money transfers;
h) electronic transmission services for movies, radio and television programs, either live, delayed or per view;
i) movies, radio and television programs either live, delayed or per view;
j) prepared foods;
k) food and groceries in general and other merchandise;
l) food preparation orders either to be eaten in a restaurant or for take-out;
m) purchase orders for grocery, supermarket or market products;
n) purchase or delivery orders for industrial and office supplies;
o) purchase or delivery orders of construction materials or manufacturing raw materials;
p) purchase or delivery orders for medicines; and
q) purchase of ticket to cultural, social or recreational events.

In order to carry out the methods involved in this invention that have been previously mentioned, consideration is being given to the use of a variety of devices that via keypads, buttons, or specific or alphanumeric function keys, use radio electric spectrums to transmit voice, data or information that carry them via these radio electric spectrum frequencies and via digital devices to the various telecommunication company telephone exchanges and from there, using communication links via any of the methods, only as an example but not limited to, the following:
i) Internet;
ii) Frame-Relay;
iii) X25;
iv) MPLS;
v) PPTP;
vi) PPOE;
vii) GPRS;
viii) TDMA,
   as well as TCP/IP communication protocol, version 4, version 6, or any other later or future version, to communicate with computer equipment or application servers that, using the methods described in this invention, process the information so that the result is the transaction of payments for services and goods described herein, using any of the following methods:
bank card or commercial credit card;
bank card or commercial debit card;
pre-paid bank card or commercial credit card;
transfer of funds between bank accounts, merchants, savings institutions, investment companies and pawn shops;
bank deposits made in cash or check in any currency, including payment requests.

As an additional feature, the methods used by this invention are carried out in a secure operation plan based on the following considerations:
three-way authentication: using password, telephone number, network address of the Internet protocol (TCP/IP) and log on password;
information encryption between the terminal and the server;
SSL encryption certificate in the Web portal management pages. Additionally, the methods of this invention are preferably pre-payment, therefore the customers/users using the terminal must plan ahead and deposit in the operating company's account, an amount that covers the electronic air time that the company plans to sell. By using this system, customers/users can carry out, only as an example and by no means inclusive, any of the following activities:
sale of air time from a variety of companies;
technical support via the terminal;
report of deposits made;
balance requests provided instantaneously and in real-time;
requests to return surplus balances;
payment transactions for various services, as outlined in this document;
receipt of confirmation codes for operations transacted;
transmission of SMS, MMS, and similar type messages, to end customers that requested payments.

These and other features and advantages will be more clearly understood from the following detailed description taken in conjunction with the accompanying drawings and claims.

### BRIEF DESCRIPTION OF THE DRAWINGS

This invention will be described in greater detail with references to drawings, plans or diagrams that illustrate the various payment transactions of the invention. However, the drawings are only illustrative, and do not show all the various transaction features and methods of the invention.

FIG. 1 is a flowchart that illustrates one mode of operation pursuant to this invention in accordance with at least one illustrated embodiment.

FIG. 2 is a block diagram that illustrates an example of this invention applied to the pre-payment of electronic air time in accordance with at least one illustrated embodiment.

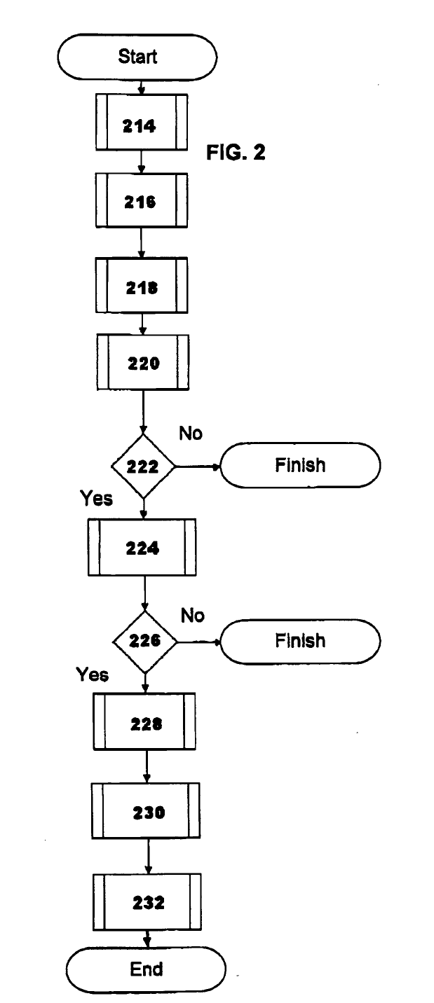

FIG. 3 is a block diagram that illustrates an example of this invention applied to pre- and post-paid long distance phone card plans in accordance with at least one illustrated embodiment.

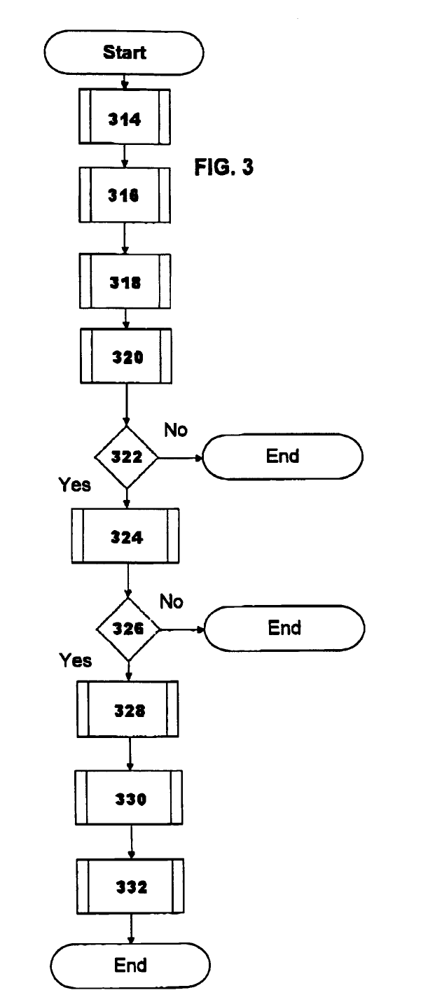

FIG. 4 is a block diagram that illustrates an example of this invention applied to enabling the use of the Internet using a mobile phone or portable communication device for a fixed period of time in accordance with at least one illustrated embodiment.

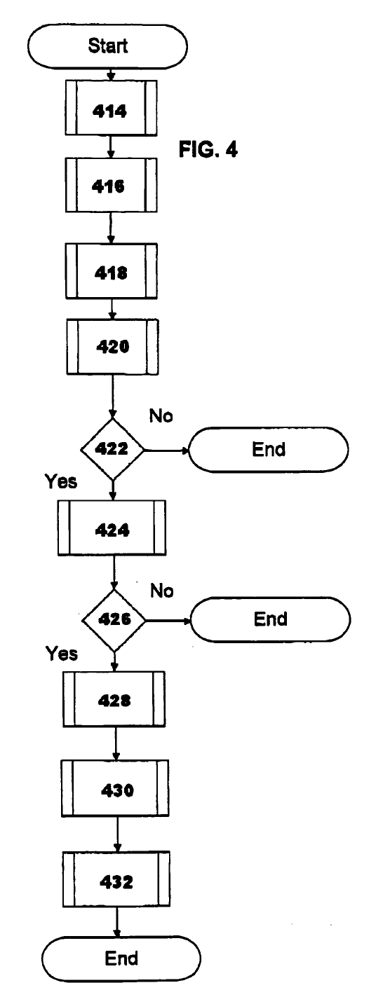

FIG. 5 is a block diagram that illustrates an example of this invention applied to the purchase of airplane or land transportation tickets in accordance with at least one illustrated embodiment.

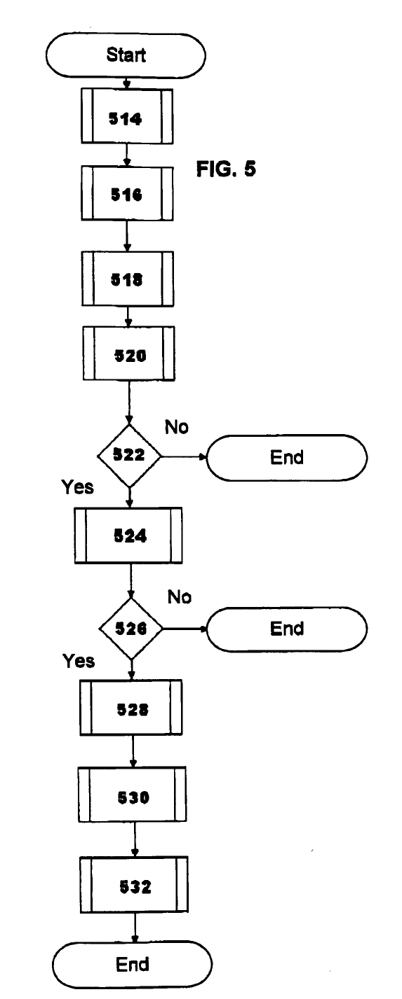

FIG. 6 is a block diagram that illustrates an example of this invention applied to the purchase of lottery, raffle, drawing and sports wagering event tickets in accordance with at least one illustrated embodiment.

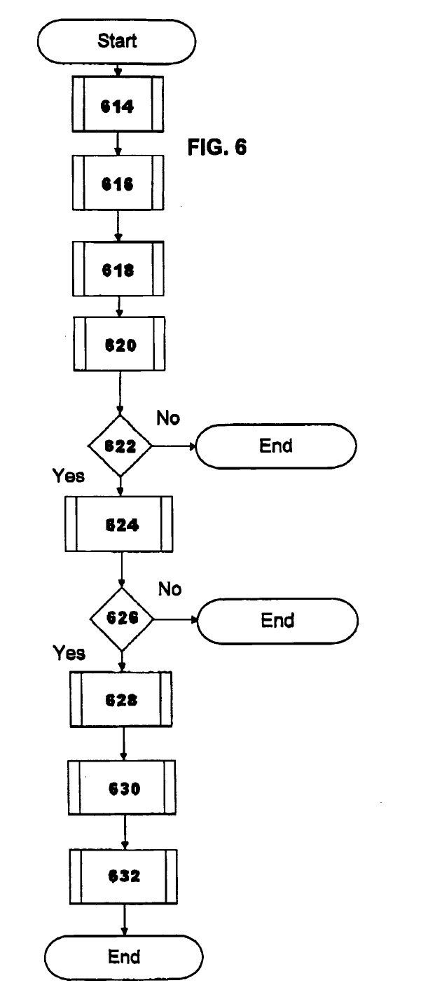

FIG. 7 is a block diagram that illustrates an example of this invention applied to money transfers to accounts in financial institutions in accordance with at least one illustrated embodiment.

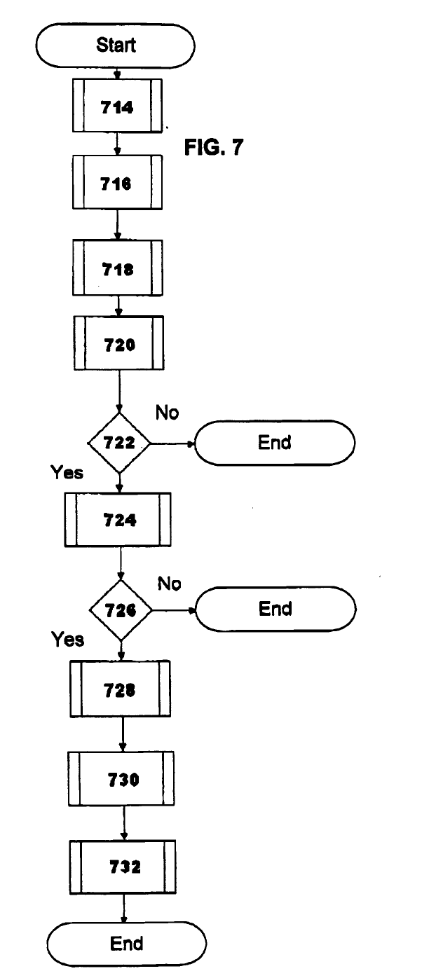

FIG. 8 is a block diagram that illustrates an example of this invention applied to the electronic transmission of movies, radio and television programs, either live, delayed or per view in accordance with at least one illustrated embodiment.

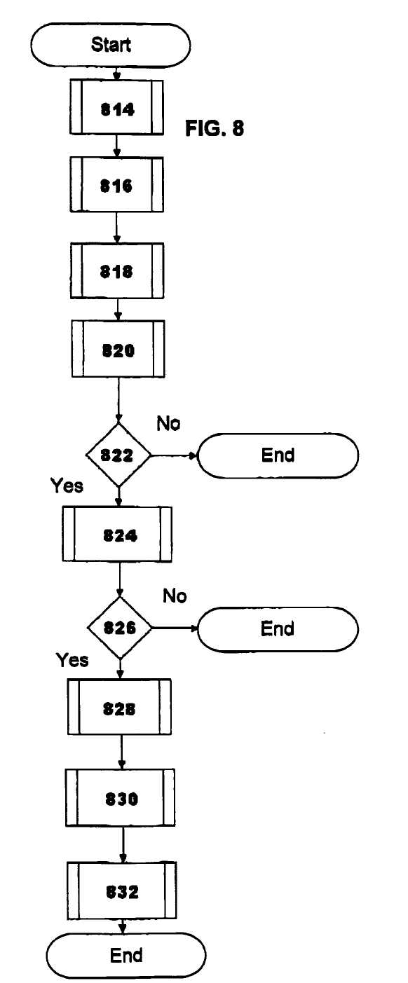

FIG. 9 is a block diagram that illustrates an example of this invention applied to ordering food and merchandise transactions in general in accordance with at least one illustrated embodiment.

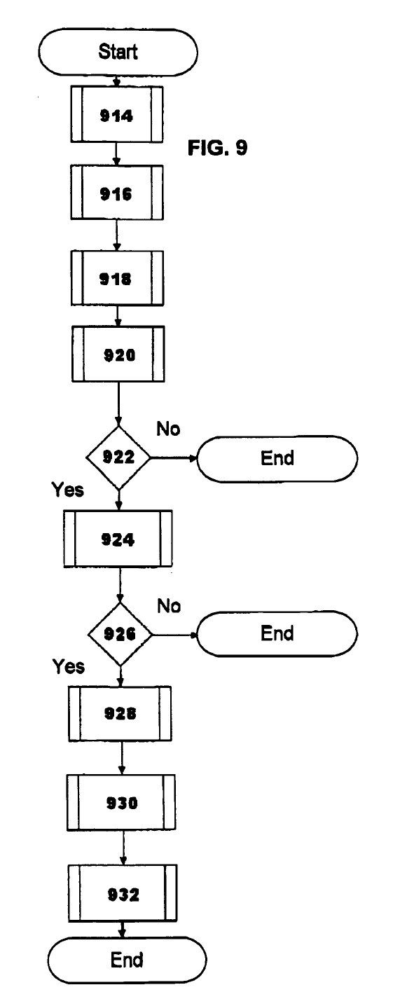

FIG. 10 is a block diagram that illustrates an example of this invention applied to ordering goods and materials in general in accordance with at least one illustrated embodiment.

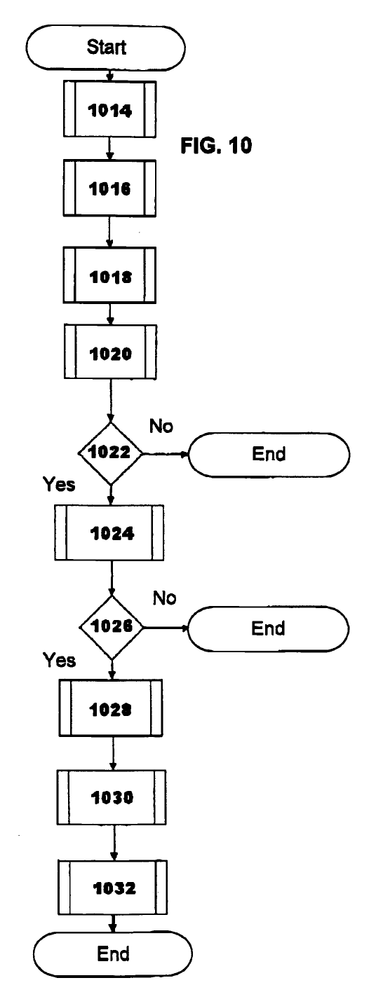

### DETAILED DESCRIPTION

The following is a detailed description of the invention's fundamental features, with reference to the accompanying drawings that illustrate how the transactions work and the invention's various characteristics. This description shall only be an example and should not be interpreted as all inclusive.

Certain terms are used throughout the following claims and description to refer to particular components. As one skilled in the art will appreciate, different entities may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean an optical, wireless, indirect electrical, or direct electrical connection. Thus, if a first device couples to a second device, that connection may be through a direct electrical connection, through an indirect electrical connection via other devices and connections, through an optical connection, or through a wireless connection. Additionally, the term “system” refers to a collection of two or more hardware components, and may be used to refer to an electronic device

The current disclosure, on the one hand, in general terms refers to payment methods via wireless electronic devices that use the radio electric spectrum, through the use of a variety of technologies that offer a high level of security, without the costs and complexities associated with proprietary and custom-made systems.

The current disclosure, on the other hand, also refers to payment methods via electronic devices that utilize wired transmission systems, as well as through the use of a variety of technologies that also offer a high level of security, without the costs and complexities associated with proprietary and custom-made systems.

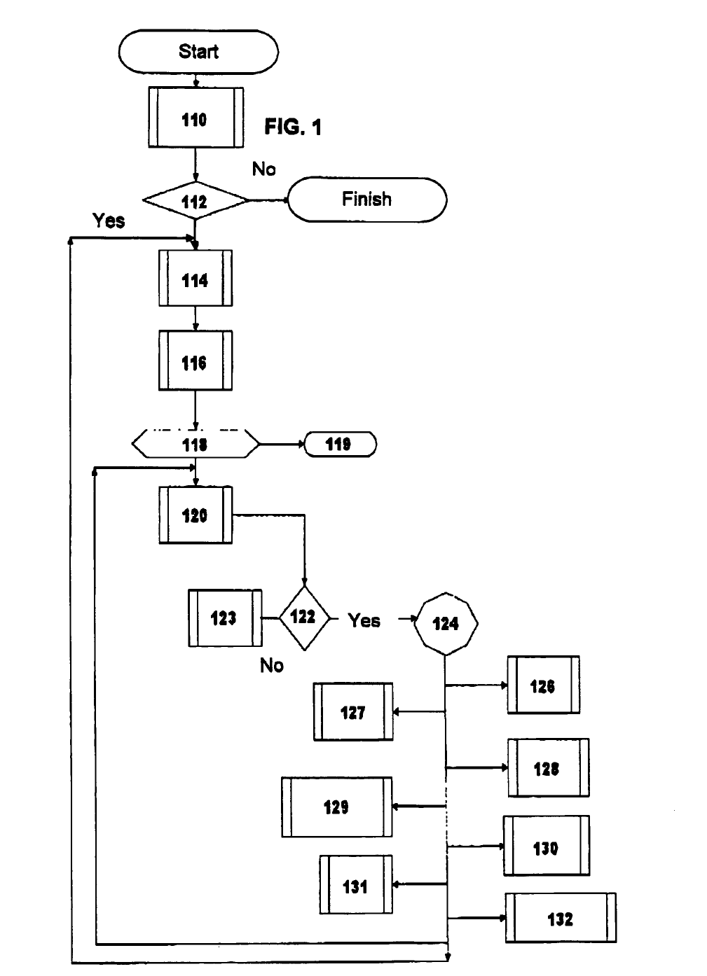

With specific reference to FIG. 1 of the drawings, this figure consists of a flowchart that shows the first transaction operation, actually the preferred, of how the methods of the invention can be utilized. As can be seen in FIG. 1, step 110, a server that implements and controls the methods of the invention starts up. In this preferred type of transaction, in step 110, after confirming the startup of the server, a TCP/IP port is opened. In step 112, operation of the server is verified, and if verification is given, the system proceeds to step 114; if verification is not given, the process is terminated. In step 114, the server determines the incoming connections of mobile phones or portable communication devices, and in step 116 establishes a connection with each mobile phone or portable communication device customer/user. In another type of transaction, in step 114 the server determines the incoming connections of wired communication devices. Once the server has established a link with each active customer/user in step 116, it maintains the link in step 118; if there is no connection, the link in step 119 is terminated. The process continues in step 120, where, with the active link or connection, information about the customer/user is read. In step 122, the system that implements the invention's methods determines if there is customer/user data, otherwise the connection with the customer/user is terminated in step 123. If this is the case, the process continues to step 124, which includes implementation of a security step for verification purposes. Beginning with step 124, the system, on the one hand, carries out operations such as verification of balances and authorizations or permissions from customer/users (step 126), verification of customers/users, including record of bank deposits (step 128), verification of requests from customer/users (step 130), and verification of users and available balances, carrying out operations such as transferring a balance from one terminal to another (step 132).

On the other hand, in step 127 the process continues verifying the customer/user and carries out a bank transfer, verifying the customer/user and registering the sale of air time (step 129), and capturing data in a chat reference table (step 131).

Please note that as an obvious result, in the first type of transaction the customer/user's mobile phone or portable communication device operates like a terminal for the system that carries out the invention's payment transactions. In another type of transaction, it is a wired communication device that operates as the terminal. For the purpose of the description, the terms “mobile phone”, “portable communication device” and “wired communication device” are used interchangeably with the term “terminal” in the sense of a customer/user terminal for a system that works via one or more computers.

Although it is not shown in FIG. 1, it should be mentioned that the indicated steps related to the methods of the invention are carried out in an operational framework that has three security levels:
three-way authentication, i.e. password, telephone number, IP address and password to log onto the system;
encryption of the information transferred between one terminal and the server that carries out the system's operation;
issuance of an SSL encryption certificate in the Web portal management pages.

This three-level security framework is carried out in a very simple manner, without any interference with the system's efficient and rapid operation and with no undue delays or interruptions in the customers/user's payment transactions.

On the other hand, it is apparent from observing the detailed description in FIG. 1, one of the invention's advantages is that it can be used with any mobile phone, portable communication device or wired communication device, because after contracting the payment transaction service, the needed software is downloaded to the corresponding telephone or device in order for the system to operate efficiently, using any appropriate mode. This advantage also allows the customer/user's telephone or device to include screens that are appropriate for the application or specific interest applications.

The following is additional information about the various features of the invention, with reference to the following examples, that are an integral part of the description and should be used for illustration purposes only and not be limited to the following.

### EXAMPLE 1

### Air Time Pre-Payment

As an example of pre-paying air time for mobile phone users, the method starts by establishing a connection between the portable communication device, such as a mobile phone, and the server (step 216). This connection can be established, for example, by sending a pre-payment air time request from the customer/user's mobile phone to the server (step 214). The request can include, only as an example but not limited to, the buyer's telephone number to which the air time pre-payment will be made, the buyer's mobile telephony service provider, and/or the amount of the pre-paid air time, among other things (step 218). Once the server receives the request to pre-pay air time (step 220), the system carries out the indicated operations, beginning with verification of the customer/user (step 222). Once the customer/user is verified, the server processes the request to pre-pay air time (step 224), verifies the customer/user's permission to carry out the pre-payment, if he/she has a balance that will cover the pre-payment of air time (step 226), and if he/she does, the system logs the sale of the air time and subtracts the amount from the account balance (step 228). The server sends confirmation of the transaction to the customer/user (step 230), which can include, only as an example but not limited to, the amount of the transaction and/or the customer/user's current balance, among other things. Additionally, the buyer can receive on his/her own mobile phone confirmation of the transaction including, only as an example but not limited to, the amount of the transaction, when the air time will expire, and/or his/her current balance, among other things (step 232).

It is important to mention, because this is obvious to any professional in the industry, the difference between the customer/user's mobile phone and the buyer's mobile phone. In the case of the customer/user's mobile phone, this mobile phone is used as the payment terminal or the invention's point of sale payment method, while the buyer's mobile phone is the mobile phone that has contracted a communication service with a communication service provider and, in this case, requires pre-payment of air time for the communication service with whom he/she has contracted. As previously indicated, the customer/user's mobile phone is being used as an example, but it can be substituted for any other portable communication device, only as an example but not limited to, a personal digital assistant (PDA), portable computer, for example laptop or notebook, handheld computer, such as a palmtop, two-way communication device, etc., among other things.

### EXAMPLE 2

### Purchase of Long Distance Telephone Cards

As an example of the purchase of long distance phone cards, the method starts by establishing a connection between the portable communication device, such as a mobile phone, and the server (step 316). This connection can be established, for example, by sending a long distance phone card request from the customer/user's mobile phone to the server (step 314). The request can include, only as an example but not limited to, the long distance telephony service provider, the code of the long distance phone card and/or the amount of the long distance phone card, among other things (step 318). Once the server receives the request to purchase a long distance phone card (step 320), the system carries out the indicated operations, beginning with verification of the customer/user (step 322). Once the customer/user is verified, the server processes the request to purchase the long distance phone card (step 324), verifies the customer/user's permission to carry out the purchase, if he/she has a balance that will cover the purchase (step 326), and if he/she does, the system logs the sale of the long distance phone card time and subtracts the amount from the account balance (step 328). The server sends confirmation of the transaction to the customer/user (step 330), which can include, only as an example but not limited to, the amount of the transaction, the customer/user's current balance, and/or an access code or password in order to use the long distance phone card, among other things. In this way, with the confirmation, the user/customer can give the buyer the actual long distance phone card and/or any relevant information, e.g. the access code or the password (step 332).

### EXAMPLE 3

### Purchase of Internet Time for Predetermined Periods of Time

An example of purchasing Internet time for predetermined periods of time, the method starts by establishing a connection between the portable communication device, such as a mobile phone, and the server (step 416). This connection can be established, for example, by sending a request to purchase Internet time for predetermined periods of time from the customer/user's mobile phone to the server (step 414). The request can include, only as an example but not limited to, the Internet service provider, the time period to be used, the amount of Internet time purchased, and/or, if this is available, the buyer's user name, among other things (step 418). Once the server receives the request to purchase Internet time (step 420), the system carries out the indicated operations, beginning with verification of the customer/user (step 422). Once the customer/user is verified, the server processes the request to purchase Internet time, verifies the customer/user's permission to carry out the purchase, if he/she has a balance that will cover the purchase (step 426), and if he/she does, the system logs the sale of Internet time use and subtracts the amount from the account balance (step 428). The server sends confirmation of the transaction to the customer/user (step 430), which can include, only as an example but not limited to, the amount of the transaction, the customer/user's current balance, and/or an access code or password in order to use the Internet, among other things. In this way, with the confirmation, the user/customer can give the buyer a receipt or any relevant information, e.g. the time period of Internet use, the access code and/or the password (step 432).

### EXAMPLE 4

### Purchase of Transportation Tickets

An example of the purchase of transportation tickets, the method starts by establishing a connection between the portable communication device, such as a mobile phone, and the server (step 516). This connection can be established, for example, by sending a request to purchase transportation tickets from the customer/user's mobile phone to the server (step 514). The request can include, only as an example but not limited to, the transportation services required, amount to be paid, and/or, the expiration date of the transportation ticket to be purchased, among other things (step 518). Once the server receives the request to purchase transportation tickets (step 520), the system carries out the indicated operations, beginning with verification of the customer/user (step 522). Once the customer/user is verified, the server processes the request to purchase transportation tickets (step 524), verifies the customer/user's permission to carry out the purchase, if he/she has a balance that will cover the purchase of transportation tickets (step 526), and if he/she does, the system logs the sale of the transportation tickets and subtracts the amount from the account balance (step 528). The server sends confirmation of the transaction to the customer/user (step 530), which can include, only as an example but not limited to, the amount of the transaction, the customer/user's current balance, and/or a code or the number of the transaction, among other things. In this way, with the confirmation, the user/customer can give the buyer a receipt or any relevant information, e.g. the actual transportation ticket (step 532).

### EXAMPLE 5

### Purchase of Lottery, Drawing, Raffle and Similar Tickets

As an example of the purchase of lottery, raffle, drawing and similar tickets, the method starts by establishing a connection between the portable communication device, such as a mobile phone, and the server (step 616). This connection can be established, for example, by sending a request to purchase lottery, raffle, drawing and similar tickets from the customer/user's mobile phone to the server (step 614). The request can include, only as an example but not limited to, the type of ticket to be purchased, amount to be paid, and/or, the expiration date of the ticket to be purchased, among other things (step 618). Once the server receives the request to purchase lottery, raffle, drawing and similar tickets (step 620), the system carries out the indicated operations, beginning with verification of the customer/user (step 622). Once the customer/user is verified, the server processes the request to purchase lottery, raffle, drawing and similar tickets (step 624), verifies the customer/user's permission to carry out the purchase, if he/she has a balance that will cover the purchase (step 626), and if he/she does, the system logs the sale of the tickets and subtracts the amount from the account balance (step 628). The server sends confirmation of the transaction to the customer/user (step 630), which can include, only as an example but not limited to, the amount of the transaction, the customer/user's current balance, and/or a code or the number of the transaction, among other things. In this way, with the confirmation, the user/customer can give the buyer a receipt or any relevant information, e.g. the actual lottery, raffle, drawing and similar ticket (step 632).

### EXAMPLE 6

### Money Transfer Transactions

As an example of money transfer transactions, the method starts by establishing a connection between the portable communication device, such as a mobile phone, and the server (step 716). This connection can be established, for example, by sending a request for a money transfer transaction from the customer/user's mobile phone to the server (step 714). The request can include, only as an example but not limited to, the type of transfer to be transacted, the amount of the transfer, the destination account (only as an example but not limited to, a bank account or the account of another user that utilizes the invention's server), and/or, the date the transfer is to be made, among other things (step 718). Once the server receives the request to transfer money (step 720), the system carries out the indicated operations, beginning with verification of the customer/user (step 722). Once the customer/user is verified, the server processes the request to transfer money (step 724), verifies the customer/user's permission to carry out the operation, if he/she has a balance that will cover the transfer (step 726), and if he/she does, the system logs the money transferred and subtracts the amount from the account balance (step 728). The server sends confirmation of the transaction to the customer/user (step 730), which can include, only as an example but not limited to, the amount of the transfer, the customer/user's current balance, and/or a code or the number of the transaction, among other things.732

### EXAMPLE 7

### Electronic Content Transmission

As an example of electronic content transmission (only as an example but not limited to, tones, games and other content for various devices e.g., mobile phones), the method starts by establishing a connection between one portable communication device, such as a mobile phone, and the server (step 816). This connection can be established, for example, by sending a request for the electronic transmission of content from the customer/user's mobile phone to the server (step 814). The request can include, only as an example but not limited to, the content to be transmitted electronically, some reference to the device from which the content will be transmitted (only as an example but not limited to, the mobile phone number), and/or the amount to be paid, among other things (step 818). Once the server receives the request to transmit electronic content (step 820), the system carries out the indicated operations, beginning with verification of the customer/user (step 822). Once the customer/user is verified, the server processes the request to transmit electronic content (step 824), verifies the customer/user's permission to carry out the purchase, if he/she has a balance that will cover the purchase (step 826), and if he/she does, the system logs the sale of the electronic content transmission and subtracts the amount from the account balance (step 828). The server sends confirmation of the transaction to the customer/user (step 830), which can include, only as an example but not limited to, the amount of the transaction, the customer/user's current balance, and/or a number or code of the operation, among other things. In this way, the buyer can then receive the electronic content transmission that was requested (step 832).

### EXAMPLE 8

### Food and Merchandise Order Transactions

As an example of food and merchandise order transactions (only as an example but not limited to, pizza orders, stationery orders, etc.), the method starts by establishing a connection between one portable communication device, such as a mobile phone, and the server (step 916). This connection can be established, for example, by sending a food and merchandise order transaction request from the customer/user's mobile phone to the server (step 914). The request can include, only as an example but not limited to, the details of the order, the delivery address, and/or the amount to be paid, among other things (step 918). Once the server receives the order request to purchase food or merchandise (step 920), the system carries out the indicated operations, beginning with verification of the customer/user (step 922). Once the customer/user is verified, the server processes the request to purchase food or merchandise(step 924), verifies the customer/user's permission to carry out the purchase, if he/she has a balance that will cover the purchase (step 926), and if he/she does, the system logs the food and merchandise transaction and subtracts the amount from the account balance (step 928). The server sends confirmation of the transaction to the customer/user (step 930), which can include, only as an example but not limited to, the amount of the transaction, the customer/user's current balance, and/or a number or code of the operation, among other things. In this way, the buyer can then receive the food or merchandise that was requested (step 932).

### EXAMPLE 9

### Goods and Materials Order Transactions

As an example of ordering goods and materials, the method starts by establishing a connection between the portable communication device, such as a mobile phone, and the server (step 1016). This connection can be established, for example, by sending an order request to purchase goods and materials from the customer/user's mobile phone to the server (step 1014). The request can include, only as an example but not limited to, the details of the order, the delivery address, and/or the amount to be paid, among other things (step 1018). Once the server receives the order request of goods and materials (step 1020), the system carries out the indicated operations, beginning with verification of the customer/user (step 1022). Once the customer/user is verified, the server processes the request to purchase (step 1024), verifies the customer/user's permission to carry out the purchase, if he/she has a balance that will cover the purchase (step 1026), and if he/she does, the system logs the goods and materials purchase and subtracts the amount from the account balance (step 1028). The server sends confirmation of the transaction to the customer/user (step 1030), which can include, only as an example but not limited to, the amount of the transaction, the customer/user's current balance, and/or a number or code of the operation, among other things. In this way, the buyer can then receive the goods and materials that were requested (step 1032).

In at least one embodiment, a method comprises determining at least one portable communication device connection. The method further comprises verifying customer/user information associated with the portable communication device, and recording an amount of a payment operation requested by the customer/user on behalf of a buyer. The customer/user is not the same as the buyer. The method further comprises transferring the amount of the payment operation, and confirming that the payment operation was executed.

In at least one embodiment the connection occurs over a private cellular network, and the connection is between the portable communication device and a server. The connection is secure is secure in various embodiments, and the connection does not comprise SMS, USSID, or Internet. In at least one embodiment, confirming comprises sending confirmation that the payment operation was executed to the buyer or a second portable communication device associated with the buyer.

In various embodiments, transferring comprises deducting the amount from an account associated with the customer/user, and sending a message to a financial institution using the financial institution's messaging protocol.

In various embodiments, the payment operation comprises pre-payment of electronic air time provided by a first carrier, and another payment operation comprises pre-payment of electronic air time provided by a second carrier. The electronic airtime is associated with a second portable communication device associated with the buyer in at least one embodiment.

In various embodiments, the customer/user information resides on a SIM card in the portable communication device, and the SIM card also contains software able to retrofit any phone into a payment terminal.

However, the disclosure is not limited to the sale of air time. Rather many types of payment operations are possible. For example, the payment operation can be: authorization to use a long distance phone card in a pre- or post-paid plan; authorization to use Internet on the portable communication device; airplane or land transportation tickets; sale of tickets to cultural, social or recreational events; sale of lottery, raffle, drawing or sports wagering tickets; money transfer transactions; electronic transmission of movies, radio programs, or television programs, and wherein said transmission is live, delayed or pay per view; orders of prepared food delivered to the home; grocery orders; purchase orders of industrial and office supplies; purchase orders of construction materials; or purchase orders of medicines.

In various embodiments, the connection is made via one or more protocols such as Internet, Frame-Relay, X25, MPLS, PPTP, PPOE, GPRS, TDMA and TCP/IP; and the payment operation is associated with an instrument such as a bank card, credit card, debit card, pre-paid card, or transfer of funds between bank accounts, merchants, savings institutions, investment companies, or pawn shops.

The system described above may be implemented on a particular machine with sufficient processing power, memory resources, and network throughput capability to handle the necessary workload placed upon it. Such a machine includes a processor (which may be referred to as a central processor unit or CPU) that is in communication with a machine-readable medium. The machine-readable medium may comprise memory devices including secondary storage, read only memory (ROM), and random access memory (RAM). The processor is further in communication with input/output (I/O) devices and network connectivity devices. The processor may be implemented as one or more CPU chips.

The secondary storage is typically comprised of one or more disk drives or tape drives and is used for non-volatile storage of data and as an over-flow data storage device if RAM is not large enough to hold all working data. Secondary storage may be used to store programs which are loaded into RAM when such programs are selected for execution. The ROM is used to store instructions and perhaps data which are read during program execution and cause the processor to perform any of the steps described in this disclosure. ROM is a non-volatile memory device which typically has a small memory capacity relative to the larger memory capacity of secondary storage. The RAM is used to store volatile data and perhaps to store instructions. Access to both ROM and RAM is typically faster than to secondary storage.

I/O devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity devices may enable the processor to communicate with an Internet or one or more intranets. With such a network connection, the processor may receive information from the network, or may output information to the network in the course of performing the above-described method steps. Such information, which is often represented as a sequence of instructions to be executed using processor, may be received from and output to the network, for example, in the form of a computer data signal embodied in a carrier wave

Such information, which may include data or instructions to be executed using processor for example, may be received from and output to the network, for example, in the form of a computer data baseband signal or signal embodied in a carrier wave. The baseband signal or signal embodied in the carrier wave generated by the network connectivity devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor executes instructions, codes, computer programs, scripts which it accesses from hard disk, floppy disk, optical disc (these various disk based systems may all be considered secondary storage), ROM, RAM, or the network connectivity devices.

In the material where the term “includes” or “including” are used in the description or claims, these terms imply that they will be inclusive in the same way as the term “which consists of,” “consisting of,” or “comprising”, as this term is interpreted when it is used as a transition word in a claim. Furthermore, to the extent that the term “or” (e. g., A or B) is used, this will mean “A or B or both”. When the applicants stipulate “only A or B but not both”, then the term “only A or B but not both” will be used. In this way, use of the term “or” in this document is inclusive, and not exclusive. Furthermore, to the extent that the term “connect” is used in the description or claims, this implies that it means not only “connected directly to”, but also “connected indirectly to”, as connected via another component or multiple components.

Although this application illustrates the various forms of transactions, and although these forms of transactions have been described in certain detail, the applicant does not attempt to restrict or in any other way limit the scope of the invention claimed in the details. Any additional advantages and modifications will be obvious to the professional in the subject matter. As such, taking into consideration the major features of the invention, the invention, per se is not limited to the specific details and illustrative examples shown and described herein. Therefore, it is possible to deviate from the details without deviating from the invention's spirit or scope as claimed by the applicant. Moreover, the forms of transactions previously described are illustrative, and no element or characteristic in and of itself is essential to all the possible combinations that can be claimed in this or in any later application. For example, various illustrated steps within a particular sequence can combine with one another or in addition can be separated from one another. Furthermore, steps described in one diagram can be incorporated into another diagram. Moreover, the functionality described can be provided by hardware and/or software, and can be distributed or combined on one platform. Additionally, the functionality described in a particular example can be achieved in a different way than the way that was illustrated, but it still is included in this disclosure. Therefore, the claims should be interpreted broadly, consistent with this disclosure.

1. A method, comprising:
determining at least one portable communication device connection;
verifying customer/user information associated with the portable communication device;
recording an amount of a payment operation requested by the customer/user on behalf of a buyer, the customer/user not the same as the buyer;
transferring the amount of the payment operation; and
confirming that the payment operation was executed.

2. The method of claim 1, wherein the connection occurs over a private cellular network.

3. The method of claim 1, wherein the connection is between the portable communication device and a server.

4. The method of claim 1, wherein the connection is secure.

5. The method of claim 1, wherein the connection does not comprise SMS, USSID, or Internet.

6. The method of claim 1, wherein confirming comprises sending confirmation that the payment operation was executed to the buyer.

7. The method of claim 6, wherein sending confirmation comprises sending confirmation to a second portable communication device associated with the buyer.

8. The method of claim 1, wherein transferring comprises deducting the amount from an account associated with the customer/user.

9. The method of claim 1, transferring comprises sending a message to a financial institution using the financial institution's messaging protocol.

10. The method of claim 1, wherein the payment operation comprises pre-payment of electronic air time provided by a first carrier.

11. The method of claim 10, wherein another payment operation comprises pre-payment of electronic air time provided by a second carrier.

12. The method of claim 10, wherein the electronic airtime is associated with a second portable communication device associated with the buyer.

13. The method of claim 1, wherein the customer/user information resides on a SIM card in the portable communication device.

14. The method of claim 1, wherein the payment operation is selected from the group consisting of authorization to use a long distance phone card in a pre- or post-paid plan; authorization to use Internet on the portable communication device; airplane or land transportation tickets; sale of tickets to cultural, social or recreational events; sale of lottery, raffle, drawing or sports wagering tickets; money transfer transactions; electronic transmission of movies, radio programs, or television programs, and wherein said transmission is live, delayed or pay per view; orders of prepared food delivered to the home; grocery orders; purchase orders of industrial and office supplies; purchase orders of construction materials; and purchase orders of medicines.

15. The method of claim 1, wherein the at least one connection is made via one or more protocols selected from the group consisting of Internet, Frame-Relay, X25, MPLS, PPTP, PPOE, GPRS, TDMA and TCP/IP.

16. The method of claim 1, wherein the payment operation is associated with an instrument selected from a group consisting of bank card, credit card, debit card, pre-paid card, and transfer of funds between bank accounts, merchants, savings institutions, investment companies, or pawn shops.

17. A system comprising:
a processor;
a memory coupled to the processor;
wherein the processor
determines at least one portable communication device connection;
verifies customer/user information associated with the portable communication device;
records an amount of a payment operation requested by the customer/user on behalf of a buyer, the customer/user not the same as the buyer;
transfers the amount of the payment operation; and
confirms that the payment operation was executed.

18. The system of claim 17, wherein the connection occurs over a private cellular network.

19. The system of claim 17, wherein the connection is between the portable communication device and a server.

20. The system of claim 17, wherein the connection is secure.

21. The system of claim 17, wherein the connection does not comprise SMS, USSID, or Internet.

22. The system of claim 17, wherein confirming comprises sending confirmation that the payment operation was executed to the buyer.

23. The system of claim 22, wherein sending confirmation comprises sending confirmation to a second portable communication device associated with the buyer.

24. The system of claim 17, wherein transferring comprises deducting the amount from an account associated with the customer/user.

25. The system of claim 17, transferring comprises sending a message to a financial institution using the financial institution's messaging protocol.

26. The system of claim 17, wherein the payment operation comprises pre-payment of electronic air time provided by a first carrier.

27. The system of claim 26, wherein another payment operation comprises pre-payment of electronic air time provided by a second carrier.

28. The system of claim 26, wherein the electronic airtime is associated with a second portable communication device associated with the buyer.

29. The system of claim 17, wherein the customer/user information resides on a SIM card in the portable communication device.

30. The system of claim 17, wherein the payment operation is selected from the group consisting of authorization to use a long distance phone card in a pre- or post-paid plan; authorization to use Internet on the portable communication device; airplane or land transportation tickets; sale of tickets to cultural, social or recreational events; sale of lottery, raffle, drawing or sports wagering tickets; money transfer transactions; electronic transmission of movies, radio programs, or television programs, and wherein said transmission is live, delayed or pay per view; orders of prepared food delivered to the home; grocery orders; purchase orders of industrial and office supplies; purchase orders of construction materials; and purchase orders of medicines.

31. The system of claim 17, wherein the at least one connection is made via one or more protocols selected from the group consisting of Internet, Frame-Relay, X25, MPLS, PPTP, PPOE, GPRS, TDMA and TCP/IP.

32. The system of claim 17, wherein the payment operation is associated with an instrument selected from a group consisting of bank card, credit card, debit card, pre-paid card, and transfer of funds between bank accounts, merchants, savings institutions, investment companies, or pawn shops.

33. A machine-readable storage medium comprising executable instructions that, when executed, cause one or more processors to:
determine at least one portable communication device connection;
verify customer/user information associated with the portable communication device;
record an amount of a payment operation requested by the customer/user on behalf of a buyer, the customer/user not the same as the buyer;
transfer the amount of the payment operation; and
confirm that the payment operation was executed.

34. The storage medium of claim 33, wherein the connection occurs over a private cellular network.

35. The storage medium of claim 33, wherein the connection is between the portable communication device and a server.

36. The storage medium of claim 33, wherein the connection is secure.

37. The storage medium of claim 33, wherein the connection does not comprise SMS, USSID, or Internet.

38. The storage medium of claim 33, wherein confirming comprises sending confirmation that the payment operation was executed to the buyer.

39. The storage medium of claim 38, wherein sending confirmation comprises sending confirmation to a second portable communication device associated with the buyer.

40. The storage medium of claim 33, wherein transferring comprises deducting the amount from an account associated with the customer/user.

41. The storage medium of claim 33, transferring comprises sending a message to a financial institution using the financial institution's messaging protocol.

42. The storage medium of claim 33, wherein the payment operation comprises pre-payment of electronic air time provided by a first carrier.

43. The storage medium of claim 42, wherein another payment operation comprises pre-payment of electronic air time provided by a second carrier.

44. The storage medium of claim 42, wherein the electronic airtime is associated with a second portable communication device associated with the buyer.

45. The storage medium of claim 33, wherein the customer/user information resides on a SIM card in the portable communication device.

46. The storage medium of claim 33, wherein the payment operation is selected from the group consisting of authorization to use a long distance phone card in a pre- or post-paid plan; authorization to use Internet on the portable communication device; airplane or land transportation tickets; sale of tickets to cultural, social or recreational events; sale of lottery, raffle, drawing or sports wagering tickets; money transfer transactions; electronic transmission of movies, radio programs, or television programs, and wherein said transmission is live, delayed or pay per view; orders of prepared food delivered to the home; grocery orders; purchase orders of industrial and office supplies; purchase orders of construction materials; and purchase orders of medicines.

47. The storage medium of claim 33, wherein the at least one connection is made via one or more protocols selected from the group consisting of Internet, Frame-Relay, X25, MPLS, PPTP, PPOE, GPRS, TDMA and TCP/IP.

48. The storage medium of claim 33, wherein the payment operation is associated with an instrument selected from a group consisting of bank card, credit card, debit card, pre-paid card, and transfer of funds between bank accounts, merchants, savings institutions, investment companies, or pawn shops.
